(19) United States
(12) Patent Application Publication
(10) Pub. No.: US 2023/0238554 A1
(43) Pub. Date: Jul. 27, 2023

(54) METHOD FOR STARTING UP A FUEL CELL SYSTEM AFTER A STANDSTILL

(71) Applicant: HOERBIGER ANTRIEBSTECHNIK HOLDING GMBH, Schongau (DE)

(72) Inventors: Jochen SCHAIBLE, Schongau (DE); Aleksandar PERICEVIC, Schongau (DE); Ansgar DAMM, Schongau (DE)

(21) Appl. No.: 18/130,694

(22) Filed: Apr. 4, 2023

Related U.S. Application Data
(63) Continuation of application No. PCT/EP2021/077096, filed on Oct. 1, 2021.

(30) Foreign Application Priority Data
Oct. 6, 2020 (DE) 10 2020 126 150.0

(51) Int. Cl. H01M 8/04225; H01M 8/04089; H01M 8/04111

(52) U.S. Cl. CPC H01M 8/04225; H01M 8/04097; H01M 8/04111; H01M 2008/1095

(57) ABSTRACT

A fuel cell system is provided that includes a fuel cell with an assembly of multiple individual cells, each of which has an anode section, an electrolyte membrane, and a cathode section, an anode gas supply, which leads to an anode gas inlet and includes a fuel cell and a fuel metering device, a cathode gas supply, and a passive anode gas recirculation device, which connects an anode gas outlet to the recirculation gas inlet of a mixer arranged in the anode gas supply. The fuel cell system is started up after a standstill in that in a first phase, the fuel cell is activated while fuel is supplied from the fuel source, and the anode recirculation is suppressed without actively blocking the anode gas recirculation device, and in a second phase, anode gas is recirculated in addition to the supply of fuel from the fuel source.

### CROSS REFERENCE TO RELATED APPLICATIONS

This application is a continuation under 35 U.S.C. §120 of International Application PCT/EP2021/077096, filed Oct. 1, 2021, which claims priority to German Application No. 10 2020 126 150.0, filed Oct. 6, 2020, the contents of each of which are incorporated by reference herein.

### FIELD OF THE INVENTION

The present invention relates to a fuel-cell system, which comprises an actual fuel cell having an arrangement of several individual cells provided respectively with an anode portion, an electrolyte membrane and a cathode portion, an anode-gas supply that leads to an anode-gas inlet and comprises a fuel source and a fuel-metering device, a cathode-gas supply and an anode-gas recirculation device that connects an anode-gas outlet with the recirculation-gas inlet of a mixer disposed in the anode-gas supply. In particular, the present invention relates to the powering-up of such a fuel-cell system after a stoppage.

### BACKGROUND

Fuel-cell systems of the type in question here and mentioned in the introduction, in which especially hydrogen is used as fuel, are found in the prior art in diverse different variants - e.g. different with regard to the realization of the anode-gas recirculation with a conveying fan (so-called “active recirculation”) or else without such (so-called “passive recirculation”) due to use of a mixer that exerts a suction action and in particular is constructed as a jet pump. They are currently attracting attention because of their use in motor vehicles with electric drive. It is precisely - but not only - for this field of application that, due to the unavoidable frequent stoppage times, aspects related to the behavior of the fuel cell and the processes taking place therein during powering-down from power operation, during the subsequent stoppage and during powering-up again after the stoppage are demanding special attention.

EP 1 627 442 Bl, EP 1 897 165 Bl, DE 10 2007 037 304 B4, KR 10-1080782 Bl, DE 10 2011 105 054 Al, DE 10 2018 218 083 Al and US 2019/0148746 Al, to the content of which reference is made here, contain partly qualified, more or less extensive discussions of the processes in a fuel cell during its stoppage and the problems resulting therefrom. According to US 2019/0148746 Al, which relates to a fuel-cell system having passive anode-gas recirculation, an active solenoid valve that can be actuated via an actuator is provided within the anode-gas recirculation device. This is used, in conjunction with a storage volume likewise provided within the anode-gas recirculation device, for purposeful generation of turbulences when a deficiency in function is diagnosed via a reduced voltage of the fuel cell. The knowledge derived in DE 10 2011 105 054 Al, which likewise concerns a fuel-cell system having passive anode-gas recirculation, then leads to the idea that, at least during the process of starting a fuel cell, at least one measure will be provided for intensifying the convection and/or turbulences within the anode portion. In this context, such a pulsed mode of operation of a valve arrangement provided in the anode-gas supply, whereby anode-gas recirculation is already initiated during the starting phase, so that intensive mixing of the anode-side gases is achieved even when the outlet valve of the anode portion is closed, is specifically regarded as such a convection-intensifying measure. Other proposals tend in the opposite direction, namely the implementation of more or less complex (unproductive) flushing cycles.

Despite the considerable need for this, as ultimately also expressed by the large number of various proposals made heretofore - only a selection from the prior art is indicated in the foregoing - a convincing practical solution for powering up a fuel cell (or a fuel-cell system) from stopped condition has been lacking heretofore, wherein a minimum time requirement until the onset of productive operation, small structural or equipment-related complexity, high energy efficiency as well as high reliability and operational safety are to be regarded especially as relevant criteria for practical suitability in this respect, wherein a conflict of objectives sometimes exists between these criteria and necessitates a compromise (e.g. between minimum time requirement until productive operation and high energy efficiency). With the general objective of improvement of fuel-cell technology, the present invention is therefore based, starting from the presented prior art, and with regard to the problem of stoppage of fuel cells, on creating a remedy and providing a practical solution, especially in the form of an improved method, compared with the method according to DE 10 2011 105 054 Al, for successfully powering up a fuel cell, especially a low-temperature fuel cell operated with hydrogen, or a fuel-cell system comprising such a fuel-cell, after a stoppage.

### SUMMARY

This task is accomplished according to embodiments of the invention in that the powering-up of a fuel-cell system having a passive anode-gas recirculation device takes place over at least two phases in such a way that, in a first phase of powering-up (“initialization phase”), the fuel cell is set in operation by feeding fuel from the fuel source, wherein the anode-gas recirculation - without active shutoff of the anode-gas recirculation device by means of an element actuated externally, especially by activation of an associated actuator by a control unit - is suppressed, and anode-gas recirculation takes place, in addition to the feeding of fuel from the fuel source, only in a second phase of powering-up (“consolidation phase”) that follows the first phase in time. The invention therefore departs expressly from the technical teaching disclosed by DE 10 2011 105 054 Al, in that anode-gas recirculation is suppressed or prevented in the starting phase. In the starting phase, during which the fuel cell is set in operation with feeding of fuel from the fuel source, a valve that is present if necessary in the anode-gas outlet is not closed, but to the contrary is opened, in contrast to what is suggested in DE 10 2011 105 054 Al. The invention therefore builds on the knowledge - contrary to the teaching according to DE 10 2011 105 054 Al - that the recirculation of anode gas via the recirculation device during initialization of powering-up of the fuel cell is disadvantageous rather than advantageous. In the process, however, the anode-gas recirculation is not suppressed (i.e. completely or at least largely prevented) by an element embedded in the (passive) anode-gas recirculation device and actuated externally (especially by activation of an associated actuator by a control unit), because the anode-gas recirculation device precisely does not have such an externally actuated element.

Accordingly, during the initialization phase, the anode-gas recirculation device plays virtually no role at all or at least acts largely as if it were not even present. Hereby the quantity of gas present there - the gas quantity is definitely considerable due to the typically large flow cross sections of the anode-gas recirculation device - is also irrelevant for the first phase of powering-up of the fuel cell, i.e. it does not act in inhibiting or otherwise interfering manner, and especially not on the purging and initialization processes. In that the onset of anode-gas recirculation is suppressed or prevented during the initialization phase, the action of purging of the fuel cell by admission of fuel thereto leads to such an effect that the fuel cell begins its productive operation earlier than in the case of immediate onset of anode-gas recirculation. This result is then achieved according to embodiments of the invention without a separate active shutoff device, which would be associated with complexity related to equipment and control technology as well as necessarily to disadvantageous effects on reliability and operational safety.

If, according to a preferred embodiment of the invention, the mixer is formed by a jet pump, it is - according to a further particularly advantageous further development of the invention - solely the mode of operation of the jet pump via which anode-gas recirculation is suppressed in the initialization phase. The jet pump is accordingly operated in the initialization phase in such a way that its suction effect generated at the recirculation-gas inlet is negligible or at least only so small that -considering the further fluidic influencing variables - noteworthy anode-gas recirculation does not occur. In particular, therefore, it is evident that all measures aimed at a strong or increased suction effect of the mixer are deliberately omitted in the initialization phase; changeover to such measures takes place only in the consolidation phase, in which anode-gas recirculation - appropriately delayed - is activated.

In a further preferred configuration of the invention, the influence on the jet pump (forming the mixer) takes place, solely by influencing the feeding of fuel to the mixer, to the effect that no suction effect causing (noteworthy) anode-gas recirculation occurs at the recirculation-gas inlet during the initialization phase. For this purpose, it is possible in particular to refrain intentionally from a pulsating feed of fuel to the jet nozzle in the initialization phase, i.e. it is possible to feed the fuel (hydrogen, etc.) to the jet pump as uniformly as possible with a more or less constant low mass flow. According to the aforesaid, it is therefore possible within the scope of the present invention, according to a preferred configuration thereof, for the equipment-related configurations of the anode-gas recirculation device as well as of the mixer (the jet pump) to be identical in the first and second phases of powering-up of the fuel cell, i.e. during the initialization phase and the consolidation phase, in that the different operating characteristics result exclusively from variation of the fuel supply to the mixer.

However, the foregoing is not obligatory. To the contrary, it is also entirely conceivable for the equipment-related configuration of the anode-gas recirculation device and/or of the mixer (the jet pump) to be different in the initialization phase from that in the consolidation phase - albeit with the proviso that, for this purpose, the anode-gas recirculation device not be equipped with an actively switchable shutoff device (see US 2019/0148746 Al). The change in the equipment-related configuration of the mixer (the jet pump) may then take place, for example, by modification - caused directly by appropriate pressure changes, which if necessary depend directly on the fuel inlet pressure present in the fuel supply - of the position of the propellant nozzle relative to the other components; because the suction behavior of the jet pump is decisively dependent on this. Similar considerations apply to a modification - again caused directly by appropriate pressure changes, which if necessary depend directly on the fuel inlet pressure present in the fuel supply - of other geometric conditions of the jet nozzle (e.g. diffusor angle, diffusor length, opening cross-section of the suction port, etc.).

The change in the equipment-related configuration of the anode-gas recirculation device take place in particular via an optional passive closure device. Such a device that influences the flow through the anode-gas recirculation device, operates without external energy and without external activation and is suitable for blocking the flow cross-section of the anode-gas recirculation device is to be regarded as a passive closure device in this sense. The changeover between the blocked position and the (completely) open position then takes place autonomously, automatically and directly on the basis of an internal variable, namely the pressure conditions prevailing in the region of the closure device itself.

In the interest of particularly high efficiency of the fuel-cell system, this passive closure device has a well-defined switching point, so that, if the appropriate prerequisites (e.g. pressure conditions) exist, it changes over (switches) more or less abruptly from its blocking state to the state of release of maximum flow cross section. A closure device that is quite particularly suitable for this purpose is described in detail hereinafter.

### BRIEF DESCRIPTION OF THE DRAWING

The present invention will be explained in more detail hereinafter on the basis of two exemplary embodiments illustrated in the drawing, wherein

FIG. 1 shows a schematic diagram of a first fuel-cell system suitable for carrying out the invention, wherein the fuel cell is symbolized on the basis of one of its individual cells,

FIG. 2 shows a schematic diagram of a second fuel-cell system suitable for carrying out the invention and

FIG. 3 shows, in an enlarged diagram, the passive closure device implemented in the fuel-cell system according to FIG. 2 in closed as well as in opened position.

### DETAILED DESCRIPTION OF THE PREFERRED EMBODIMENTS

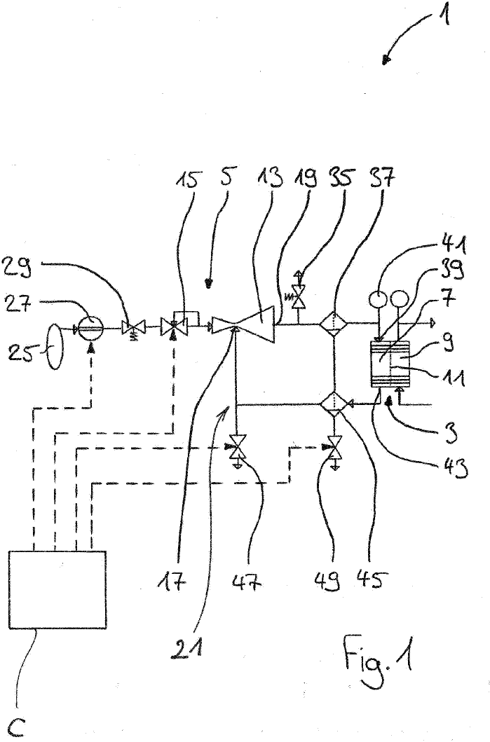

FIG. 1 schematically shows a fuel-cell system 1 suitable for carrying out embodiments of the invention. It comprises in particular a fuel cell 3 - symbolized by one of its individual cells - and a fuel-metering device in the form of a jet pump control-valve unit 5. Fuel cell 3 has, in conventional manner, an anode chamber 7, a cathode chamber 9 and an electrolyte membrane 11 separating anode chamber 7 and cathode chamber 9 from one another. Jet-pump control-valve unit 5 comprises a jet pump 13 - forming a mixer -and a fuel-gas control valve 15, and is connected via a suction port 17 and a pressure port 19 to anode chamber 7. It is used for metered charging of anode chamber 7 with fuel gas and, depending on operating phase and mode (see below), for recirculation of an anode gas via an anode-gas recirculation device 21. For this purpose, the fuel gas present under high pressure in fuel source 25 first passes an opened shutoff valve 27, before its pressure is reduced in a pressure regulator 29. Under control of fuel-gas control valve 15, the fuel gas, forming the propellant gas, then flows into jet pump 13, i.e. into its propellant jet nozzle.

A control unit C of the fuel-cell system acts in particular on the fuel-gas control valve 15. Via the corresponding effect, the feeding of fuel to jet pump 13 may be varied in multiple respects. Firstly, the fuel throughput (averaged over time), i.e. the average quantity of fuel per unit time, is adjustable. Secondly, the characteristic of the fuel supply is adjustable, and specifically within a considerable bandwidth. This ranges from a steady, continuous flow of fuel gas through fuel-gas control valve 15, which flow can be adjusted to different flow rates, to pulsed flow behavior with different frequency, different relation of the duration of opening and closing phases relative to one another as well as different opening and/or closing characteristics (e.g. rectangular profile, triangular profile, sawtooth profile, wave profile, etc.). By appropriate influence on the flow of fuel gas through fuel-gas control valve 15, it is possible to influence the suction behavior of jet pump 13, and, in fact, specifically in such a way that, in a first phase of powering-up (“initialization phase”), the fuel cell is set in operation with feeding of fuel from the fuel source, wherein, for lack of sufficient suction behavior of jet pump 13, recirculation of anode gas through anode-gas recirculation device 21 is suppressed and does not take place, in contrast to which, in a second phase of powering-up (“consolidation phase”) that takes place in time after the first phase, recirculation of anode gas through anode-gas recirculation device 21 takes place in addition to the feeding of fuel from fuel source 25, as a result of sufficient suction behavior of jet pump 13. In the consolidation phase, the fuel gas stream in the mixing chamber of jet nozzle 13 entrains - just as later in power operation of the fuel cell, after completion of powering-up - anode gas, which is sucked in through suction port 17 and mixed with (fresh) fuel gas to form mixed gas. The mixed gas exits jet pump 13 through pressure port 19 and flows past safety valve 35 and through an (optional) first condensate separator 37, before it flows into anode chamber 7 of fuel cell 3 through an anode-chamber inlet 39. In the region of anode-chamber inlet 39, state parameters of the mixed gas (e.g. temperature, pressure, gas-mixing ratio) relevant to control and operation are recorded by means of a sensor 41. The anode gas sucked out of anode chamber 7 through an anode-chamber outlet 43 passes a (second) condensate separator 45 used for separation of condensation water and flows past a flush valve 47, which permits removal of foreign gases (e.g. nitrogen) accumulated in the anode chamber. Condensation water collected in the first condensate separator 43 or second condensate separator 45 if such are provided may be drained via a condensate drain valve 49.

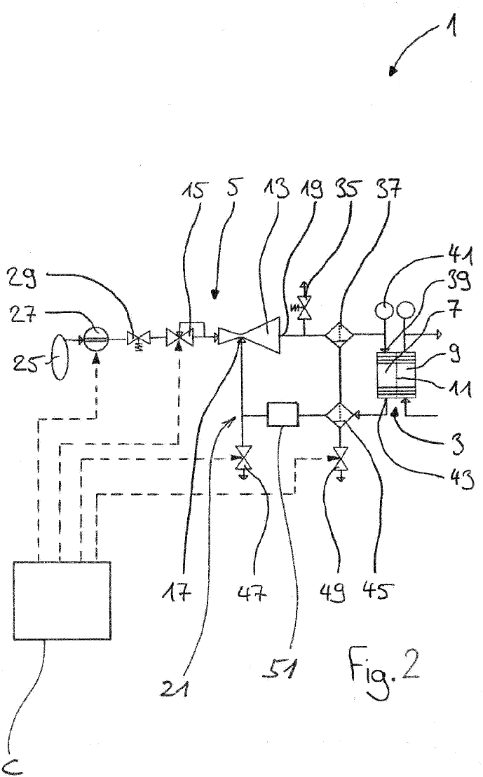

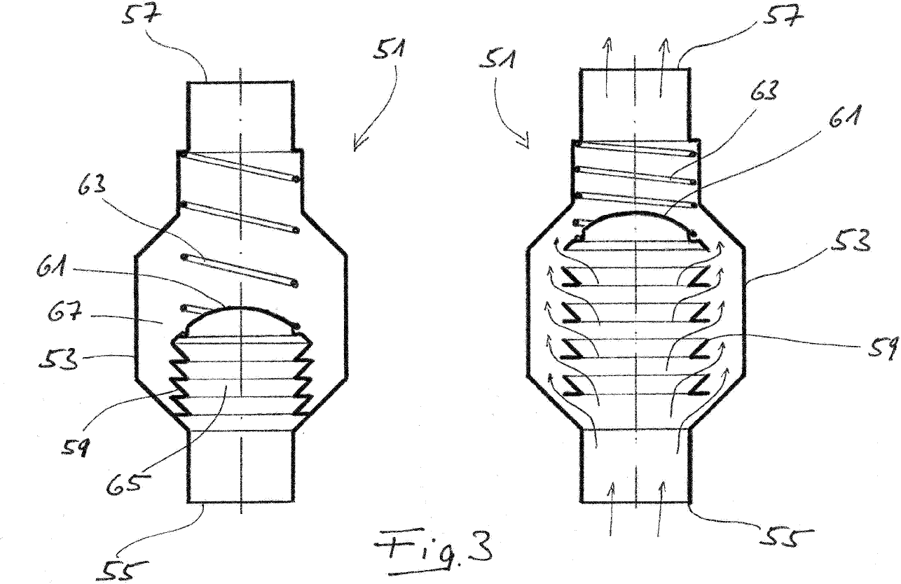

The fuel-cell system according to the second exemplary embodiment illustrated in FIG. 2 differs from that according to FIG. 1 only by an additional passive closure device 51 provided in anode-gas recirculation device 21. This comprises, as shown - partly schematically with respect to the size relationships - in FIG. 3, a housing 53 having an inlet 55 and an outlet 57. Inside housing 53, an arrangement of several of flexible rings 59 resembling angled cup springs in their shape is mounted together with an closure cap 61, which springs - in the absence of any noteworthy underpressure acting at outlet 57 - are held in contact with one another by means of a very soft spring 63 (shown at left). This inner chamber 65, bounded in sealingly closed manner in this way by the arrangement of rings 59 and closure cap 61, is in fluidic communication with inlet 55, whereas outer chamber 67 surrounding the said arrangement on the outside is in fluidic communication with outlet 57. If, due to appropriate operation of jet pump 13 (see above), a noteworthy underpressure develops at suction port 17 of jet pump 13, which is in fluidic communication with outlet 57 of closure device 51, the annular gaps between rings 59 are opened. A very large passage area for the recirculation gas is created abruptly, so that this is able to flow through anode-gas recirculation device 21 without noteworthy flow resistance. The recirculation flow that develops exerts suction - directed against the closing force of spring 63 - on closure cap 61, so that closure device 51 maintains its completely opened passing position (shown on the right) even with pressure conditions fluctuating within certain limits. For better clarity, guide and stop elements associated with rings 59 and cap 61, which bound the opening paths between the rings 59 and one another, between housing 53 and the ring adjacent thereto, and between cap 61 and the ring adjacent thereto and ensure guidance for the ring arrangement, are not illustrated.

What is claimed is:

1. A method for successfully powering up a fuel-cell system (1) after a stoppage, comprising providing:
a fuel cell (1) having an arrangement of several individual cells provided respectively with an anode portion (7), an electrolyte membrane (11) and a cathode portion (9),
an anode-gas supply that leads to an anode-gas inlet having a fuel source (25) and a fuel-metering device,
a cathode-gas supply and
a passive anode-gas recirculation device (21) that connects an anode-gas outlet with the recirculation-gas inlet of a mixer disposed in the anode-gas supply,
the method having the following steps:
in a first phase of powering-up (“initialization phase”), the fuel cell (3) is set in operation by feeding of fuel from the fuel source (25), wherein the anode-gas recirculation is suppressed, without active shutoff of the anode-gas recirculation device (21); and
in a second phase of powering-up (“consolidation phase”) following the first phase in time, anode-gas recirculation takes place in addition to the feed of fuel from the fuel source (25).

2. The method of claim 1, wherein the consolidation phase directly follows the initialization phase.

3. The method of claim 1, wherein the mixer is realized by a jet pump (13).

4. The method of claim 1, wherein the jet pump (13) is operated in the initialization phase of powering-up without suction effect at the recirculation-gas inlet of the mixer.

5. The method of claim 1, wherein the equipment-related configuration of the anode-gas recirculation device (21) is identical in the initialization phase and in the consolidation phase of powering-up of the fuel-cell system.

6. The method of claim 1, wherein the anode-gas recirculation device (21) comprises a passive closure device (51), which is closed in the initialization phase and in contrast is opened in the consolidation phase.
